(19) United States
(12) Patent Application Publication
(10) Pub. No.: US 2022/0129254 A1
(43) Pub. Date: Apr. 28, 2022

(54) OPTIMIZATION METHOD, OPTIMIZATION SYSTEM FOR COMPUTER PROGRAMMING CODE AND ELECTRONIC DEVICE USING THE SAME

(71) Applicant: INDUSTRIAL TECHNOLOGY RESEARCH INSTITUTE, HSINCHU (TW)

(72) Inventors: Jia-Rung CHANG, Taichung City (TW); Yi-Chiao SU, Miaoli City (TW); Tien-Yuan HSIEH, Hsinchu City (TW); Yi-Ping YOU, Zhubei City (TW)

(73) Assignee: INDUSTRIAL TECHNOLOGY RESEARCH INSTITUTE, HSINCHU (TW)

(21) Appl. No.: 17/109,788

(22) Filed: Dec. 2, 2020

(30) Foreign Application Priority Data
Oct. 23, 2020 (TW) 109136869

(51) Int. Cl. G06F 8/41; G06N 20/00

(52) U.S. Cl. CPC G06F 8/4441; G06N 20/00

(57) ABSTRACT

An optimization method, an optimization system for computer programming code and an electronic device using the same are provided. The optimization method includes the following steps. Several optimizers each having several branch paths are provided. A counter is set on each of the branch paths. When the optimizers run through the branch paths, the counters set on the branch paths, where the optimizer run through, are counted. The computer programming code is compiled through the optimizers. Several count values of the counters are obtained. The count values are collected to obtain a feature vector of the computer programming code. The feature vector is inputted to a machine learning model to obtain an optimizer collection suitable for the computer programming code.

This application claims the benefit of Taiwan application Serial No. 109136869, filed Oct. 23, 2020, the disclosure of which is incorporated by reference herein in its entirety.

### TECHNICAL FIELD

The disclosure relates in general to an optimization method, an optimization system for computer programming code and an electronic device using the same.

### BACKGROUND

Along with the development of software technology, various electronic devices with different functions are provided one after another. During the software development process, the programming codes need to be compiled through optimizers to remove redundant commands, such that the algorithms can be optimized, and the processing speed can be increased.

Currently, a few hundreds of optimizers regarding the optimization of programming code compiling are provided. Different optimizers have different functions. The compiling of a newly developed programming code may need several optimizers. The optimization result of an optimizer may not be applicable to all kinds of programming codes. For each programming code, a suitable optimizer collection is needed to be found. During the software development process, it is indeed a difficult task to obtain a suitable optimizer collection from tens to a few hundreds of currently available optimizers. Particularly, the optimizers are not independent and instead may interact with each other, and a set of best optimizers may not necessarily lead to the best result of optimization.

For example, among n optimizers, optimizers A, B, and C individually may not produce an optimization result on a particular programming code, but a combination of optimizers A, B, and C may produce a very good optimization result on the programming code. To select a best combination of optimizers from n optimizers, which may generate 2ⁿ possible combinations, is a complicated process known as the NP-complete problem.

### SUMMARY

The disclosure is directed to a method of an optimization method, an optimization system for computer programming code and an electronic device using the same.

According to one embodiment, an optimization method for computer programming code is provided. The optimization method includes the following steps. Several optimizers each having several branch paths are provided. A counter is set on each of the branch paths. When the optimizers run through the branch paths, the counters set on the branch paths, where the optimizers run through, are counted. The computer programming code is compiled through the optimizers. Several count values of the counters are obtained. The count values are collected to obtain a feature vector of the computer programming code. The feature vector is inputted to a machine learning model to obtain an optimizer collection suitable for the computer programming code.

According to another embodiment, an optimization system for computer programming code is provided. The optimization system for the computer programming code includes a database, a setting unit, a compiling unit, a value taking unit, a collection unit and a machine learning analysis unit. The database is configured to store several optimizers each having several branch paths. The setting unit is configured to set a counter on each of the branch paths. When the optimizers run through the branch paths, the counters set on the branch paths, where the optimizers run through, are counted. The compiling unit is configured to compile the computer programming code through the optimizers. The value taking unit is configured to obtain several count values of the counters. The collection unit is configured to collect the count values to obtain a feature vector of the computer programming code. The machine learning analysis unit is configured to input the feature vector to a machine learning model to obtain an optimizers collection suitable for the computer programming code.

According to an alternative embodiment, an electronic device is provided. The electronic device includes a processor. The processor is configured to perform an optimization method for computer programming code. The processor performing includes the following steps. Several optimizers each having several branch paths are provided. A counter is set on each of the branch paths. When the optimizers run through the branch paths, the counters set on the branch path, where the optimizers run through, are counted. The computer programming code is compiled through the optimizers. Several count values of the counters are obtained. The count values are collected to obtain a feature vector of the computer programming code. The feature vector is inputted to a machine learning model to obtain an optimizer collection suitable for the computer programming code.

### BRIEF DESCRIPTION OF THE DRAWINGS

FIG. 1 is a schematic diagram of an optimization method for computer programming code according to an embodiment.

FIG. 2 is a block diagram of an optimization system for the computer programming code according to an embodiment.

FIG. 3 is a flowchart of an optimization method for the computer programming code according to an embodiment.

FIG. 4 is an example of if-else command.

FIG. 5 is an example of switch-case command.

FIG. 6 is an example of while-loop command.

FIG. 7 is an example of do-loop command.

FIG. 8 is an example of step S120.

In the following detailed description, for purposes of explanation, numerous specific details are set forth in order to provide a thorough understanding of the disclosed embodiments. It will be apparent, however, that one or more embodiments may be practiced without these specific details. In other instances, well-known structures and devices are schematically shown in order to simplify the drawing.

### DETAILED DESCRIPTION

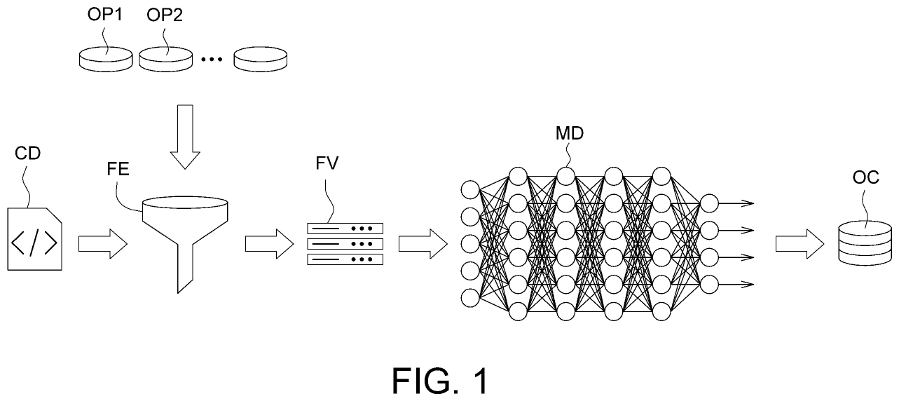

Referring to FIG. 1, a schematic diagram of an optimization method for computer programming code CD according to an embodiment is shown. In the present embodiment, a feature extraction process FE, based on the operation of all optimizers OP1, OP2, . . . , etc., extracts a feature vector FV for each computer programming code CD. After the feature vector FV is extracted, an optimizer collection OC suitable for the computer programming code CD can be predicted using a machine learning model MD. The machine learning model MD can be realized by a pre-trained neural network (NN) model.

The feature extraction process FE of the computer programming code CD is special. The relation between the optimizers OP1, OP2, . . . , etc. and the computer programming code CD is not obvious and requires complicated analysis and processing. Moreover, the computer programming code CD is not a linear vector, and cannot be directly used in the machine learning model MD. The format of the computer programming code CD needs to be converted using a specific method so that the computer programming code CD can be used in the machine learning model MD.

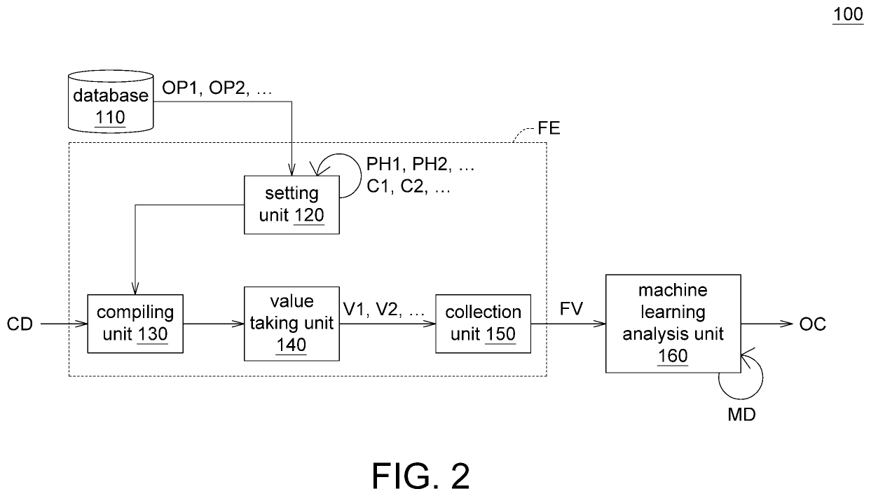

Referring to FIG. 2, a block diagram of an optimization system 100 for the computer programming code CD according to an embodiment is shown. The optimization system 100 includes a database 110, a setting unit 120, a compiling unit 130, a value taking unit 140, a collection unit 150 and a machine learning analysis unit 160. The database 110 can be realized by a memory, a hard disc or a cloud storage center. The setting unit 120, the compiling unit 130, the value taking unit 140, the collection unit 150 and the machine learning analysis unit 160 can be realized by a circuit, a circuit board or a storage device storing programming code.

The database 110 is configured to store all optimizers OP1, OP2, . . . , etc. The setting unit 120, the compiling unit 130, the value taking unit 140 and the collection unit 150 are configured to perform the feature extraction process FE to extract a feature vector FV. After the feature vector FV is obtained, the machine learning analysis unit 160 can predict the optimizer collection OC suitable for the computer programming code CD using the machine learning model MD. Operations of the above elements are disclosed below with an accompanying flowchart.

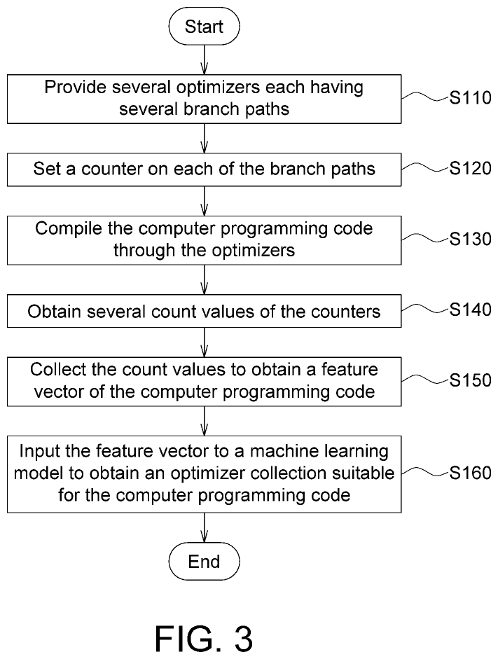

Refer to FIG. 2 and FIG. 3. FIG. 3 is a flowchart of an optimization method for the computer programming code CD according to an embodiment. The optimization method for the computer programming code CD of the present embodiment can be performed by a processor of an electronic device. The optimization method of FIG. 3 is exemplified using the optimization system 100 of FIG. 2. Firstly, the method begins at step S110 of FIG. 3, the optimizers OP1, OP2, . . . , etc. are provided by the database 110, wherein each of the optimizers OP1, OP2, . . . , etc. is a programming code, and the optimizers OP1, OP2, . . . , etc. may contain if-else command, switch-case command, while-loop command, for-loop command, do-loop command, branch command, loop command or a combination thereof. The branch path can be realized by a two-branch path, a path with more than two branches or a loop path. All the above commands are conditional commands.

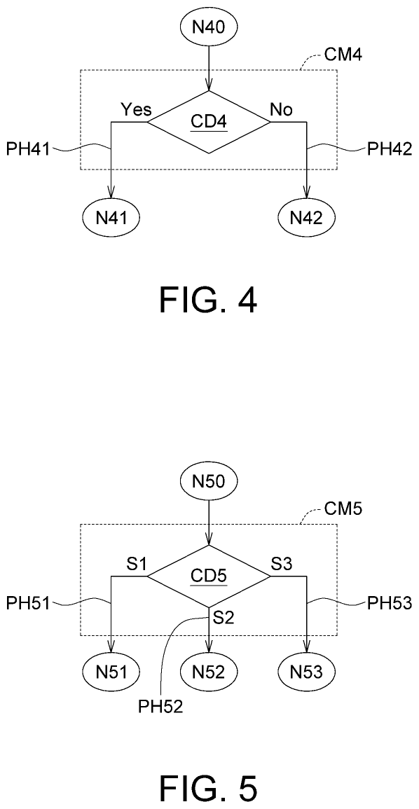

Referring to FIG. 4, an example of if-else command CM4 is shown. As indicated in FIG. 4, after exiting the node N40, the method the process performs the if-else command CM4. If the condition CD4 is met, the method enters the node N41 along the branch path PH41. If the condition CD4 is not met, the method enters the node N42 along the branch path PH42.

Referring to FIG. 5, an example of switch-case command CM5 is shown. As indicated in FIG. 5, after exiting the node N50, the process performs the switch-case command CM5. The scenario condition CD5 illustrates three scenarios S1, S2, and S3 as follows. Scenario S1: the process enters the node N51 along the branch path PH51. Scenario S2: the process enters the node N52 along the branch path PH52. Scenario S3: the process enters the node N53 along the branch path PH53. In an embodiment, the scenario condition could have two or more than four scenarios.

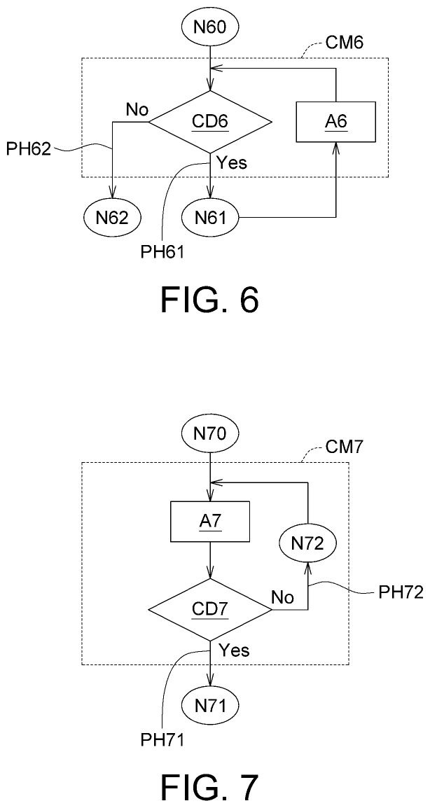

Referring to FIG. 6, an example of while-loop command CM6 is shown. As indicated in FIG. 6, after exiting the node N60, the process performs the while-loop command CM6. If the condition CD6 is met, the process enters the node N61 along the branch path PH61 to perform a particular action A6. If the condition CD6 is not met, the process enters the node N62 along the branch path PH62 to exit the loop. The for-loop command is similar to the while-loop command CM6, and the similarities are not repeated here.

Referring to FIG. 7, an example of do-loop command CM7 is shown. As indicated in FIG. 7, after exiting the node N70, the process performs the do-loop command CM7. After the action A7 is performed once, whether the condition CD7 is met is determined. If the condition CD7 is met, the process enters the node N71 along the branch path PH71 to exit the loop. If the condition CD7 is not met, the process enters the node N72 along the branch path PH72 to perform the action A7 again.

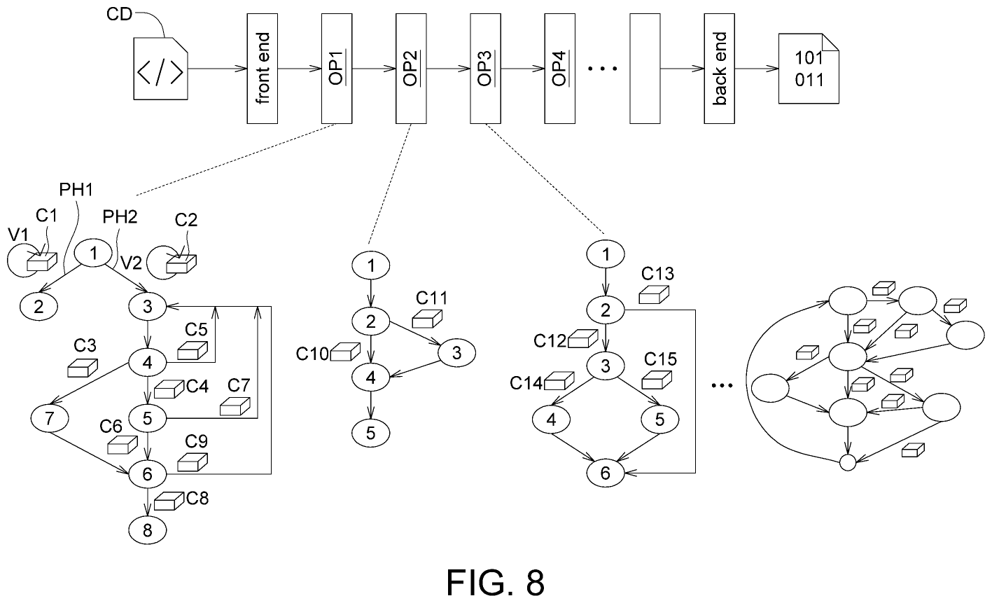

Then, the method proceeds to the step S120 of FIG. 3, counters C1, C2, . . . , etc. are respectively set on the branch paths PH1, PH2, . . . , etc. of the optimizers OP1, OP2, . . . , etc. by the setting unit 120. Referring to FIG. 8, an example of step S120 is shown. When all of the optimizers OP1, OP2, . . . , etc. are used, the optimizers OP1, OP2, OP3, OP4, . . . , etc. are arranged between the front-end and the back end of the compiling process. The optimizers OP1, OP2, OP3, OP4, . . . , etc. may contain if-else command, switch-case command, while-loop command, for-loop command and do-loop command and generate branch paths PH1, PH2, . . . , etc. The branch paths PH1, PH2, . . . , etc. can be two-branch paths or three-branch paths. In the present step, the counters C1, C2, . . . , etc. are respectively set on all of the branch paths PH1, PH2, . . . , etc. of all optimizers by the setting unit 120.

Then, the method proceeds to step S130 of FIG. 3, the computer programming code CD is compiled by the compiling unit 130 through the optimizers OP1, OP2, . . . , etc. During the compiling process, as long as the optimizers OP1, OP2, . . . , etc. run through the branch paths PH1, PH2, . . . , etc., the counters C1, C2, . . . , etc. set on the branch paths PH1, PH2, . . . , etc. will respectively increase the count values V1, V2, . . . , etc. (by 1 or 2).

Then, the process proceeds to step S140 of FIG. 3, the count values V1, V2, . . . , etc. are collected by the collection unit 150 to obtain a feature vector FV. The count values V1, V2, . . . , etc. are arranged as the feature vector FV of the computer programming code CD according to a predetermined order.

Referring to Table 1, the values of the feature vector FV obtained by complying a particular computer programming code CD through the optimizers OP1, OP2, . . . , etc. are listed.

TABLE 1

| | | | | | | | | |
|---|---|---|---|---|---|---|---|---|
| Count values | V1 | V2 | V3 | V4 | V5 | V6 | V7 | . . . |
| Feature vector | 0 | 12 | 3 | 7 | 2 | 5 | 6 | . . . |
| FV | | | | | | | | |

Then, the method proceeds to step S150 of FIG. 3, as indicated in FIG. 1, the feature vector FV is inputted to the machine learning model MD by the machine learning analysis unit 160 to obtain the optimizer collection OC suitable for the computer programming code CD. For example, the optimizer collection OC shows that suitable optimizers include optimizers OP1, OP2, and OP4.

As disclosed in above embodiments, for each computer programming code CD, the feature vector FV can be extracted through the optimizers OP1, OP2, . . . , etc. The feature vector FV represents the scenarios of operation when each computer programming code CD is compiled through the optimizers OP1, OP2, . . . , etc. That is, the feature vector FV covers the composition information of the computer programming code CD as well as the composition information of the optimizers OP1, OP2, . . . , etc.

After the feature vector FV is obtained, the optimizer collection OC suitable for the computer programming code CD can be predicted using the machine learning model MD. The optimization system of the present embodiment can automatically extract the feature vector FV according to the optimizers OP1, OP2, . . . , etc. without relying on compiler experts' expertise of optimizers.

It will be apparent to those skilled in the art that various modifications and variations can be made to the disclosed embodiments. It is intended that the specification and examples be considered as exemplary only, with a true scope of the disclosure being indicated by the following claims and their equivalents.

What is claimed is:

1. An optimization method for computer programming code, comprising:
providing a plurality of optimizers each having a plurality of branch paths;
setting a counter on each of the branch paths, wherein when the optimizers run through the branch paths, the counters set on the branch paths, where the optimizers run through, are counted;
complying the computer programming code through the optimizers;
obtaining a plurality of count values of the counters;
collecting the count values to obtain a feature vector of the computer programming code; and
inputting the feature vector to a machine learning model to obtain an optimizer collection suitable for the computer programming code.

2. The optimization method for the computer programming code according to claim 1, wherein the counters are set on all of the branch paths of the optimizers.

3. The optimization method for the computer programming code according to claim 1, wherein the branch paths comprise paths of if-else command, switch-case command, while-loop command, for-loop command, do-loop command, branch command, loop command or a combination thereof.

4. The optimization method for the computer programming code according to claim 1, wherein each of the branch paths is a two-branch path, a path with more than two branches or a loop path.

5. The optimization method for the computer programming code according to claim 1, wherein the count values are arranged as the feature vector according to a predetermined order.

6. The optimization method for the computer programming code according to claim 1, wherein the feature vector is a one-dimensional vector.

7. An optimization system for computer programming code, wherein the optimization system comprises:
a database configured to store a plurality of optimizers each having a plurality of branch paths;
a setting unit configured to set a counter on each of the branch paths, wherein when the optimizers run through the branch paths, the counters set on the branch paths, where the optimizers run through, are counted;
a compiling unit configured to compile the computer programming code through the optimizers;
a value taking unit configured to obtain a plurality of count values of the counters;
a collection unit configured to collect the count values to obtain a feature vector of the computer programming code; and
a machine learning analysis unit configured to input the feature vector to a machine learning model to obtain an optimizer collection suitable for the computer programming code.

8. The optimization system for the computer programming code according to claim 7, wherein the setting unit sets the counters on all of the branch paths of the optimizers.

9. The optimization system for the computer programming code according to claim 7, wherein the branch paths comprise paths of if-else command, switch-case command, while-loop command, for-loop command, do-loop command, branch command, loop command or a combination thereof.

10. The optimization system for the computer programming code according to claim 7, wherein each of the branch paths is a two-branch path, a path with more than two branches or a loop path.

11. The optimization system for the computer programming code according to claim 7, wherein the count values are arranged as the feature vector according to a predetermined order.

12. The optimization system for the computer programming code according to claim 7, wherein the feature vector is a one-dimensional vector.

13. An electronic device, comprising a processor configured to perform an optimization method for computer programming code, wherein the processor performing comprises:
providing a plurality of optimizers each having a plurality of branch paths;
setting a counter on each of the branch paths, wherein when the optimizers run through the branch paths, the counters set on the branch path, where the optimizers run through, are counted;
complying the computer programming code through the optimizers;
obtaining a plurality of count values of the counters;
collecting the count values to obtain a feature vector of the computer programming code; and
inputting the feature vector to a machine learning model to obtain an optimizer collection suitable for the computer programming code.

14. The electronic device according to claim 13, wherein the counters are set on all of the branch paths of the optimizers.

15. The electronic device according to claim 13, wherein the branch paths comprise paths of if-else command, switch-case command, while-loop command, for-loop command, do-loop command, branch command, loop command or a combination thereof.

16. The electronic device according to claim 13, wherein each of the branch paths is a two-branch path, a path with more than two branches, or a loop path.

17. The electronic device according to claim 13, wherein the count values are arranged as the feature vector according to a predetermined order.

18. The electronic device according to claim 13, wherein the feature vector is a one-dimensional vector.
